(19) United States
(12) Patent Application Publication
(10) Pub. No.: US 2024/0095932 A1
(43) Pub. Date: Mar. 21, 2024

(54) METHOD, NON-TRANSITORY COMPUTER READABLE STORAGE MEDIUM, TRAINING DATA SET, AND DEVICE FOR CONNECTING POINT CLOUD DATA WITH RELATED DATA

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Atsushi KITAYAMA, Nisshin-shi (JP); Hyacinth Mario Arvind ANAND, Lindau (DE); Ana-Cristina STAUDENMAIER, Lindau (DE)

(21) Appl. No.: 18/470,332

(22) Filed: Sep. 19, 2023

(30) Foreign Application Priority Data
Sep. 21, 2022 (JP) 2022-149644

(51) Int. Cl. G06T 7/246; G06F 18/24; G06T 7/277; G06T 7/73

(52) U.S. Cl. CPC G06T 7/246; G06F 18/24; G06T 7/277; G06T 7/73; G06T 2207/10028; G06T 2207/20081; G06T 2207/30252

(57) ABSTRACT

A point cloud data is connected with a related data. Multiple sets of point cloud data are prepared. Each point cloud data includes information of a point cloud connected to three-dimensional position information, and each point cloud data is connected to acquisition time. At least one group is generated by classifying the point cloud, and the group is assigned to a position label and a moving body label. A moving route of the group with a moving body on-flag is predicted based on the position label of the group. The group is replaced with a position at acquisition time of the related data according to the moving route, and the acquisition time of the related data is connected to the group.

### CROSS REFERENCE TO RELATED APPLICATION

The present application claims the benefit of priority from Japanese Patent Application No. 2022-149644 filed on Sep. 21, 2022. The entire disclosure of the above application is incorporated herein by reference.

### TECHNICAL FIELD

The present disclosure relates to a method, a non-transitory computer readable storage medium, a training data set, and a device for connecting a point cloud data with an related data.

### BACKGROUND

A conceivable technique teaches a method of measuring a distance to an object using an image sensor and a LIDAR (i.e., Light Detection And Ranging) sensor mounted on a vehicle. Image data acquired by the image sensor is transmitted to the processor in a vehicle system. The processor detects objects dotted in the acquired image data. The processor generates a region of interest for identifying a part of the image data corresponding to the detected object. Based on the LIDAR data corresponding to the time at which the image is captured and the data in the region of interest, the distance between the vehicle and the object is determined.

### SUMMARY

According to an example, a point cloud data is connected with a related data. Multiple sets of point cloud data are prepared. Each point cloud data includes information of a point cloud connected to three-dimensional position information, and each point cloud data is connected to acquisition time. At least one group is generated by classifying the point cloud, and the group is assigned to a position label and a moving body label. A moving route of the group with a moving body on-flag is predicted based on the position label of the group. The group is replaced with a position at acquisition time of the related data according to the moving route, and the acquisition time of the related data is connected to the group.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram of a connection device;

FIG. 2 is a diagram showing the situation around the vehicle;

FIG. 3 is a flowchart showing the procedure of processing according to the first embodiment;

FIG. 4 is a diagram showing a point cloud of first point cloud data acquired at a third time;

FIG. 5 is a diagram showing a view of group 1 in FIG. 4 viewed from another angle;

FIG. 6 is a diagram for explaining prediction of a moving route;

FIG. 7 is a diagram of image data acquired at image data acquisition time 4;

FIG. 8 is a diagram for explaining a second embodiment;

FIG. 9 is a diagram for explaining a third embodiment;

FIG. 10 is a flowchart showing the procedure of processing according to the fourth embodiment; and

FIG. 11 is a flowchart showing the procedure of processing according to the fifth embodiment.

### DETAILED DESCRIPTION

In a system where multiple sensors are used, the sensors may operate asynchronously. The conceivable technique proposes that, when the point cloud data generation unit and the image sensor are asynchronous, the LIDAR data at the time closest to the acquisition time of the image data is used. However, when connecting data acquired at different times with each other, the image data and the LIDAR data representing the object at different locations may be associated with each other. In that case, the error included in the calculated distance may increase.

The present disclosure can be realized as the following embodiments.

According to one aspect of the present embodiments, a method is provided for connecting a point cloud data with a related data. This method includes: (a) a step of preparing a plurality of sets of point cloud data, each of the plurality of sets of point cloud data including information of a point cloud connected to three-dimensional position information, and each of the plurality of point cloud data connected to acquired time; (b) generating at least one group by classifying the point cloud in each of two or more of sets of point cloud data, and assigning the at least one group to a label including a position label and a moving body label indicating whether the at least one group provides a moving body; (c) predicting a moving route of the at least one group assigned a moving body on-flag based on the position label of the at least one group, which is included in each of the two or more of sets of point cloud data and assigned the moving body on-flag indicating that the at least one group provides the moving body; and (d) placing the at least one group, to which the moving body on-flag is assigned, at a position of acquisition time of a related data that is acquired by a related data acquisition device for acquiring surrounding information, according to the moving route and connecting the acquisition time of the related data and the at least one group.

According to the method of this feature, a group generated by classifying point cloud data acquired at a time different from that of related data is replaced with a position at the same time as the related data and is connected to the same time of the related data. As a result, compared to a feature in which a plurality of data acquired at different times are associated to each other without being replaced with positions at the same time, the misalignment of positions between the objects represented by the related data and the objects represented by the group can be improved to be smaller. As a result, the error in the calculated distance to the object can be reduced.

### A. First Embodiment

### A1. Configuration of the First Embodiment

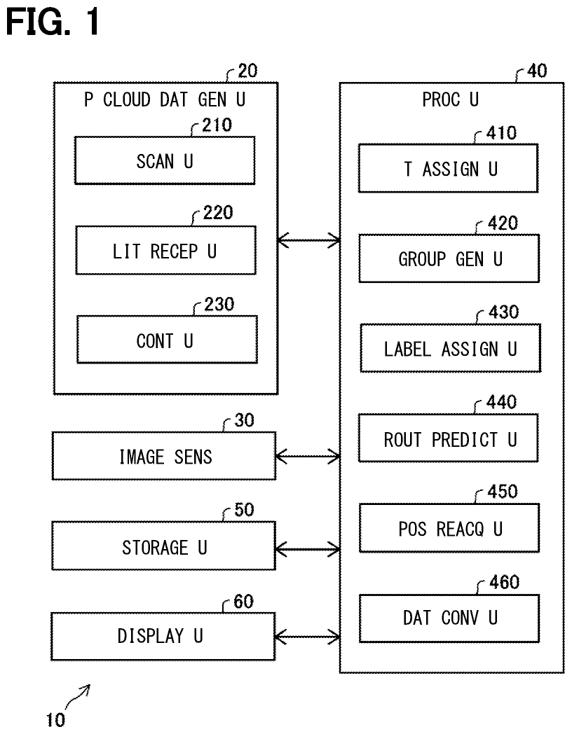

The connection device 10 shown in FIG. 1 calculates the distance to an object based on the moving object on which the connection device 10 is mounted, and generates point cloud data. Further, the connection device 10 acquires related data, which is data of surrounding information. The connection device 10 predicts a moving route of a group generated by classifying point cloud data. The connection device 10 replaces the group with the position at the acquisition time of the related data based on the moving route, and connects the group with the acquisition time of the related data. In the present embodiment, the connection device 10 predicts the moving route of the BBOX surrounding the group generated by classifying the point cloud data. The connection device 10 generates a new BBOX by placing the BBOX based on the moving route with the position at the acquisition time of the image data acquired by the image sensor 30. The connection device 10 then connects the new BBOX with the acquisition time of the image data. The BBOX will be described later.

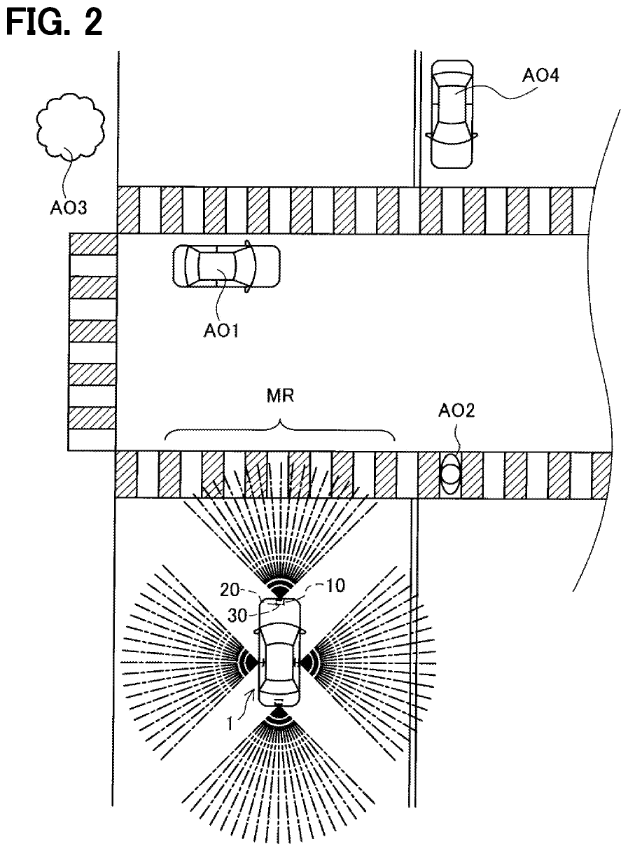

The connection device 10 of this embodiment is mounted on the vehicle 1 shown in FIG. 2. As shown in FIG. 1, the connection device 10 includes a point cloud data generation unit 20, an image sensor 30, a processing unit 40, a storage unit 50 and a display unit 60. The point cloud data generation unit 20, the image sensor 30, the storage unit 50, and the display unit 60 are electrically connected to the processing unit 40 and can exchange data with each other.

The point cloud data generation unit 20 irradiates measurement light around the vehicle 1 shown in FIG. 2 and receives reflected light from an object. The point cloud data generation unit 20 generates point cloud data based on the received reflected light. In this embodiment, a LIDAR sensor is used as the point cloud data generation unit 20. The objects are, for example, another vehicle AO1, a pedestrian AO2, a plant AO3, an oncoming vehicle AO4, and the like shown in FIG. 2. In the present embodiment, the point cloud data generation units 20 are mounted one each in the front side, the rear side, and the left side and the right side of the vehicle 1, and generate point cloud data of an object existing in each direction. In FIG. 2, the reference numerals of the point cloud data generation units 20 on the rear side, the left side and the right side of the vehicle 1 are omitted. As shown in FIG. 1, each point cloud data generation unit 20 includes a scan unit 210, a light reception unit 220 and a control unit 230.

The scan unit 210 irradiates the surroundings of the vehicle 1 with laser light, which is the measurement light. FIG. 2 shows an irradiation range MR as a part of the irradiation range irradiated with laser light. The range irradiated with the laser light is a range extending in the vertical and horizontal directions. In this embodiment, the scan unit 210 irradiates the laser light ten times per second at time intervals of 0.1 seconds. When the irradiated laser light reaches an object such as a person or a car, it is reflected by the surface of the object. The light reception unit 220 receives the reflected light.

The control unit 230 controls irradiation of laser light by the scan unit 210. Based on the information of the reflected light received by the light reception unit 220, the control unit 230 determines the time TOF (i.e., Time of Flight) from when the scan unit 210 irradiates the laser light until when the light reception unit 220 receives the reflected light. The control unit 230 calculates the distance to the object based on the time TOF and generates point cloud data. The control unit 230 generates a plurality of sets of point cloud data at regular time intervals. In this embodiment, the control unit 230 generates 10 point cloud data per second with a time interval of 0.1 second. The point cloud data is three-dimensional data that includes point cloud information connected to three-dimensional position information. The control unit 230 transmits the generated point cloud data to the processing unit 40.

The image sensor 30 acquires two-dimensional image data by imaging objects around the vehicle 1. In this embodiment, a camera is used as the image sensor 30. Each of the plurality of image sensors 30 is mounted in close proximity to each of the point cloud data generation units 20. In FIG. 2, the reference numerals of the image sensors 30 on the rear side, the left side and the right side of the vehicle 1 are omitted. The image sensor 30 is mounted on the vehicle 1 so that the imaging range overlaps with the irradiation range of the adjacent point cloud data generation unit 20. In this embodiment, the image sensor 30 acquires 10 image data per second with a time interval of 0.1 second. The image data acquired by the image sensor 30 is two-dimensional data. The image sensor 30 transmits the acquired image data to the processing unit 40.

The image sensor 30 is also defined as a device that acquires surrounding information or a surrounding information acquisition unit. The image data is also defined as related data.

The processing unit 40 expands and executes the programs stored in the storage unit 50 to function as a time assign unit 410, a group generation unit 420, a label assign unit 430, a route prediction unit 440, and a position reacquisition unit 450 and a data conversion unit 460.

The time assign unit 410 connects the point cloud data generated by the point cloud data generating unit 20 with the time when the point cloud data was obtained. The time assign unit 410 connects the image data acquired by the image sensor 30 with the time at which the image data was acquired.

The group generation unit 420 classifies the point clouds for each of the plurality of sets of point cloud data acquired by the point cloud data generation unit 20 at different times. The group generation unit 420 generates one or more groups from the group of classified point clouds. The group generation unit 420 assigns a name to each of the generated groups for identification. By assigning the name, it is possible to distinguish different groups when multiple groups are generated.

Further, in the present embodiment, the group generation unit 420 encloses the point cloud belonging to each of the generated groups with a three-dimensional rectangular box for each group. In this embodiment, the three-dimensional rectangular box is defined as a “bounding box (i.e., BBOX)”. The group generation unit 420 assigns a name for each generated BBOX. In this embodiment, after generating the BBOX, the group generation unit 420 deletes the point cloud belonging to the group enclosed by the BBOX.

The label assign unit 430 assigns the BBOX generated by the group generation unit 420 a label representing the characteristics of the BBOX. In this embodiment, the types of labels are a BBOX type label, a moving body flag label indicating whether or not the BBOX is a moving body, a BBOX position label attached with a moving body on-flag which is a moving body flag indicating that the BBOX is a moving body, a BBOX speed label attached with a moving body on-flag, a front-rear flag label indicating whether or not there is another BBOX in front of or behind the BBOX assigned with the moving body on-flag, and a BBOX dimension label. In this embodiment, the label assign unit assigns the position label for all vertices of the BBOX. Other labels are attached to the vertex selected by the label assign unit among the vertices of the BBOX.

The route prediction unit 440 predicts a moving route of a BBOX surrounding a group to which the label assign unit 430 assigns a moving object on-flag and the group is commonly included in each of two or more point cloud data. Prediction of the moving route is performed based on the position label of the BBOX assigned with the moving body on-flag.

The position reacquisition unit 450 replaces the BBOX assigned with the moving body on-flag with the position at the acquisition time of the image data acquired by the image sensor 30 based on the moving route predicted by the route prediction unit 440.

The data conversion unit 460 projects the data of the BBOX replaced with the position at the image data acquisition time in the direction in which the image sensor 30 is directed, thereby converting the BBOX data replaced with the position at the image data acquisition time into two-dimensional data. The data conversion unit 460 also converts the coordinates of the BBOX position connected by the position reacquisition unit 450 into different coordinates.

The storage unit 50 includes a ROM (not shown) and a RAM (not shown). The ROM stores in advance a program that defines the processing to be executed by the processing unit 40. Further, by the processing executed by the processing unit 40, the ROM stores data of groups generated by classification of the point cloud data, data of BBOXes surrounding the groups, data of labels attached to the groups or BBOXes, data of the moving route predicted for the groups or the BBOXes, data of the groups or BBOXes replaced with the position at the acquisition time of the related data based on the moving route, data of the groups or the BBOXes connected to the acquisition time of the related data and the like. The RAM temporarily stores data handled by the processing unit 40.

The display unit 60 displays the result of processing executed by the processing unit 40. The displayed results include time information associated with each of the point cloud data and the related data, information on the label assigned by the label assign unit 430, information on the moving route of the BBOX or the group assigned with the moving body on-flag and predicted by the route prediction unit 440, information of the group or the BBOX replaced with the position at the acquisition time of the related data based on the moving route and the like.

### A2. Method for Connecting the Point Cloud Data with the Acquisition Time of the Image Data

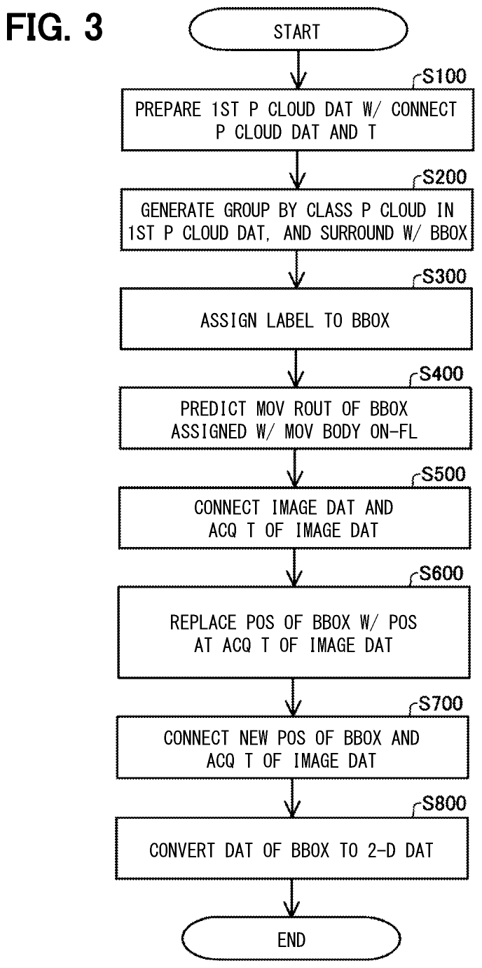

Processing of each step in FIG. 3 is executed by the processing unit 40. In step S100 of FIG. 3, the processing unit 40 connects multiple sets of point cloud data generated by the control unit 230 with the time when each point cloud data was acquired. In the present embodiment, processing is performed using all point cloud data among a plurality of sets of point cloud data acquired at intervals of 0.1 seconds, which are constant time intervals.

In the following, processing of three sets of point cloud data will now be described. The sets of point cloud data are connected to the first time as given time, the second time after 0.1 seconds has elapsed from the first time, and the third time after 0.1 seconds has elapsed from the second time. In addition, FIG. 2 represents the situation around the vehicle 1 at the third time. The point cloud data connected to time will be referred to as “first point cloud data”. The point cloud data associated with the first time is the first point cloud data DA1, the point cloud data associated with the second time is the first point cloud data DA2, and the point cloud data associated with the third time is the first point cloud data DA3. The function of step S100 is implemented by the time assign unit 410 of the processing unit 40.

In step S200, the processing unit 40 classifies the point clouds for each of the first point cloud data DA1 to the first point cloud data DA3 to generate one or more groups. Classification of the point cloud is performed using an algorithm that groups the point cloud.

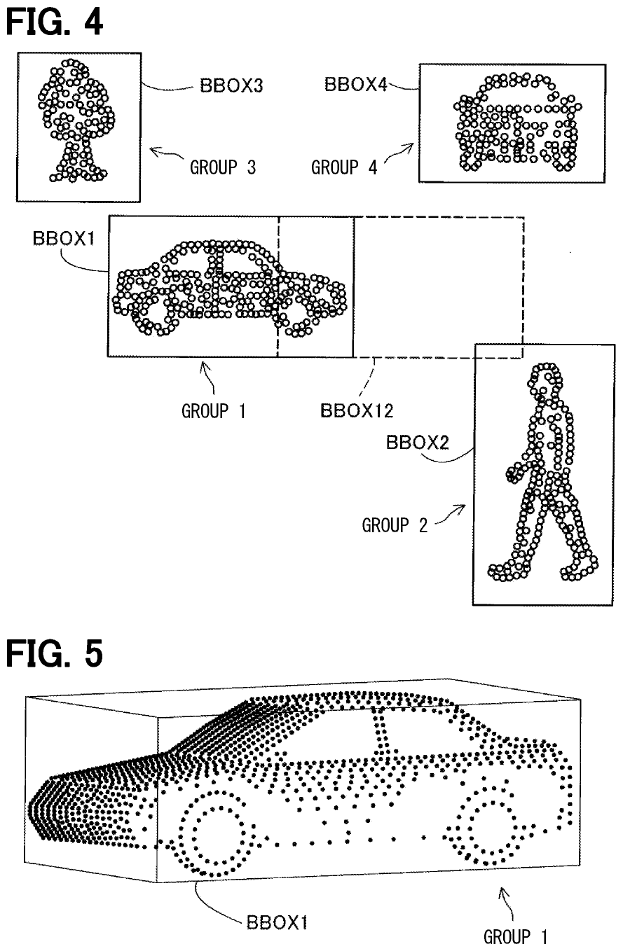

As an example, processing of the first point cloud data DA3 will be described. FIG. 4 is a diagram simply showing the first point cloud data DA3, which is point cloud data generated by the point cloud data generation unit 20 arranged in front of the vehicle 1 in FIG. 2 and associated with the third time by the processing unit 40. In FIG. 4, point clouds representing crosswalks and roads are omitted. As shown in FIG. 4, the processing unit 40 classifies the point cloud of the first point cloud data DA3 to generate four groups. The processing unit 40 assigns a group 1 to the group that constitutes the other vehicle AO1, a group 2 to the group that constitutes the pedestrian AO2, a group 3 to the group that constitutes the plant RO3, and a group 4 to the group that constitutes the oncoming vehicle AO4. Assignment may be done manually or automatically using an algorithm.

Furthermore, in step S200, the processing unit 40 surrounds each group with a BBOX, as shown in FIGS. 4 and 5. As described above, the BBOX is a three-dimensional rectangular box, here in FIG. 4, the BBOX is represented two-dimensionally. FIG. 5 shows the point cloud of group 1 and BBOX1. The processing unit 40 assigns the BBOX surrounding the group. Specifically, as shown in FIG. 4, the BBOX surrounding group 1 is assigned as BBOX1, the BBOX surrounding group 2 is assigned as BBOX2, the BBOX surrounding group 3 is assigned as BBOX3, and the BBOX surrounding group 4 is assigned as BBOX4. By assigning the BBOXes, it becomes easy to associate BBOXes at different times. Assignment may be done manually or automatically using an algorithm. After generating the BBOX, the processing unit 40 deletes the point cloud of the group surrounded by the BBOX.

Although not shown, similarly to the third time, the point clouds are classified for each of the first point cloud data DA1 associated with the first time and the first point cloud data DA2 associated with the second time to generate a group surrounded with the BBOX. In this embodiment, the first point cloud data DA1 to the first point cloud data DA3 commonly include the BBOX1 to the BBOX4, respectively. The function of step S200 is realized by the group generation unit 420 of the processing unit 40.

Hereinafter, the BBOX1 surrounding the group 1 generated by classifying the point cloud of the first point cloud data DA1 will be referred to as “the BBOX1 corresponding to the first time point”. The same applies to other BBOXes corresponding to the first time and BBOXes corresponding to the second and third times.

In step S300, the processing unit 40 assigns labels to all BBOXes corresponding to the first time to the third time. The assignment of the label is performed automatically using a group labeling tool. It should be noted that the tool for assigning a label to a group is a tool capable of similarly assigning a label to the BBOX surrounding the group. A tool program for labeling groups is incorporated in the label assign unit 430.

As an example, the label assigned to the BBOX1 corresponding to the third time will be described. A tool for assigning labels to groups assigns “vehicle” as a label representing the type to the BBOX1. By being labeled as a vehicle, the group labeling tool automatically determines that the BBOX1 represents a moving body and labels the BBOX1 as “moving body on-flag”. Also, as shown in FIG. 4, since the BBOX3 is disposed after the BBOX1, the label “rear on-flag”, which is a front/rear flag indicating that there is another BBOX behind, is assigned. “There are other BBOXes in front of or behind” means that the other BBOX overlaps the BBOX when viewed along the direction in which the measurement light of the point cloud data generation unit 20 is irradiated. In addition, each side is assigned with dimensions representing the length of each side of the BBOX1. The position labels assigned to the BBOX1 are attached to all of the box vertices of the BBOX1.

The speed labels will be described below. As described above, the BBOX1 is commonly included in the first point cloud data DA1 to the first point cloud data DA3. The processing unit 40 predicts the velocity of one vertex from the moving distance between the position label of the one vertex of the BBOX1 at the first time or the second time and the position label of the one vertex at the third time. The processing unit 40 performs the same processing on other vertices of the BBOX1 to calculate the average speed. The processing unit 40 determines the calculated average speed as the speed label of the BBOX1. Then, the processing unit 40 assigns a label representing the calculated speed to the center of gravity of the box of the BBOX1. The calculated speed may be assigned to a location other than the center of gravity of the BBOX1.

The speed of the BBOX1 corresponding to the first time is calculated using the position label assigned to the BBOX1 surrounding the group generated based on the first point cloud data acquired 0.1 seconds before the first time.

As with the BBOX1, the processing unit 40 assigns labels to the BBOX2 through the BBOX4. The BBOX2 is labeled with “person” as a label representing its type. The BBOX4 is labeled with “vehicle” as a label representing its type. The BBOX2 and the BBOX4 are all labeled in the same way as the BBOX1, including the moving body on-flag. The BBOX3 is labeled as “plant”. The BBOX labeled “plant” is automatically identified as not moving body by a tool that assigns a label to a group, and is given a moving body off-flag, which is a moving body flag indicating that it is not a moving body. Subsequent processing is not executed for the BBOX to which the moving body off-flag is assigned. The process for the BBOX1, the BBOX2, and the BBOX4 to which the moving body flag is assigned proceeds to the subsequent processing.

In step S300, all BBOXes corresponding to the first time and the second time are similarly labeled. The function of step S300 is performed by the label assign unit 430 of the processing unit 40.

The processing of the BBOX1 corresponding to the third time will be described below. In step S400, the processing unit 40 predicts the moving route of the BBOX1 after the third time based on the position label of the BBOX1. The moving route is predicted by approximating the motion of the BBOX1 to uniform linear motion.

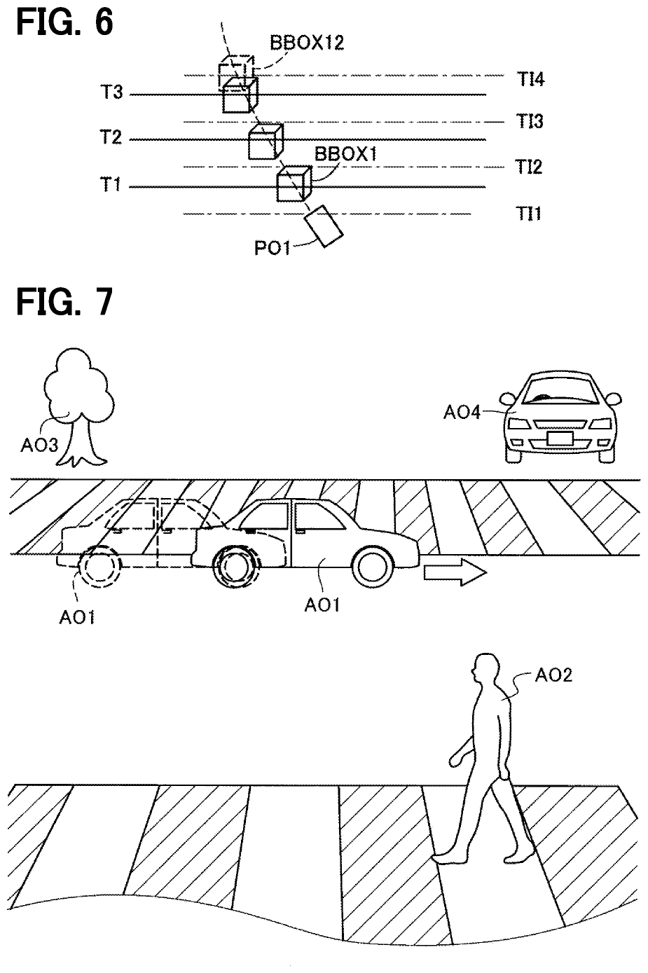

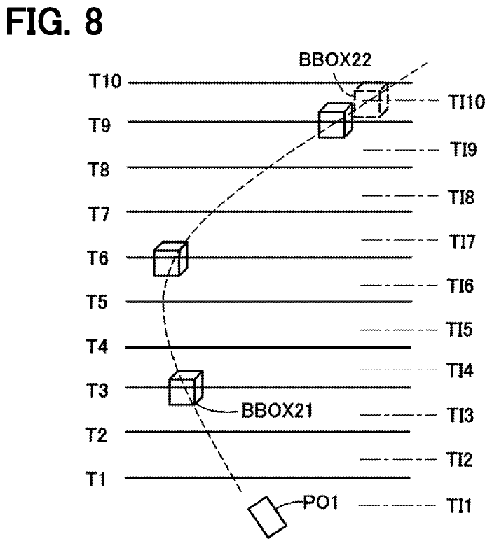

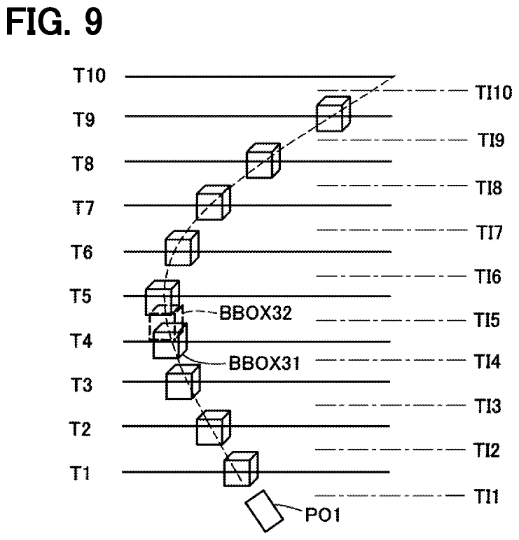

In FIG. 6, the BBOX 1 corresponding to the first to the third times is indicated by a solid line box, the predicted moving route is indicated by a broken line, and the BBOX 12 replaced with the box at the image data acquisition time is indicated by a broken line box. A line corresponding to the first time to the third time is represented by a solid line, and a line corresponding to the image data acquisition time 1 to the image data acquisition time 4 is represented by a dashed line. Further, the first time to the third time are denoted by T1 to T3, and the image data acquisition time 1 to the image data acquisition time 4 are denoted by TI1 to TI4. The same applies to FIGS. 8 and 9 as well.

Before predicting the moving route of the BBOX1 corresponding to the third time, the processing unit 40 predicts the moving route of the BBOX1 until the second time based on the BBOX1 corresponding to the first time. Next, the processing unit 40 predicts the moving route of the BBOX1 until the third time based on the BBOX1 corresponding to the second time. Then, the processing unit 40 predicts the moving route of the BBOX1 after the third time based on the BBOX1 corresponding to the third time. The process of step S400 is executed by the route prediction unit 440 of the processing unit 40.

In step S500, the processing unit 40 connects the image data acquired by the image sensor 30 with the acquisition time. The interval of each image data acquisition time shown in FIG. 6 is 0.1 second. The processing of step S500 may be performed simultaneously with any one of steps S100 to S400, or may be performed somewhere between steps S100 and S400. The function of step S500 is implemented by the time assign unit 410 of the processing unit 40.

In step S600, the processing unit 40 replaces the BBOX1 with the position at the acquisition time of the image data acquired by the image sensor 30, based on the moving route of the BBOX1 after the third time predicted in step S400. As shown in FIG. 6, in the present embodiment, the processing unit 40 replaces the BBOX with the position at the image data acquisition time 4, which is later than the third time, based on the predicted moving route of the BBOX1. Thereby, the processing unit 40 generates a new BBOX 12. The processing unit 40 assigns a position label to the BBOX 12 based on the predicted moving route. In addition to the position label, the processing unit 40 assigns the same label as the label attached to the BBOX1 in step S400 to the BBOX12. In this embodiment, the deviation between the third time and the image data acquisition time 4 is 0.04 seconds. The function of step S600 is realized by the data conversion unit 460 of the processing unit 40.

In FIG. 4, the BBOX 12, which is the BBOX of the other vehicle AO1 corresponding to the image data acquisition time 4, is represented by a dashed box. As shown in FIG. 4, the other vehicle AO1 moves from the position indicated by the solid line BBOX1 to the position indicated by the dashed line BBOX12 between the third time and the image data acquisition time 4. Further, in FIG. 7, the other vehicle AO1 at the third time is indicated by a dashed line. As shown in FIG. 7, between the third time and the image data acquisition time 4, the other vehicle AO1 moves in the direction of the white arrow from the position indicated by the broken line to the position indicated by the solid line.

As described above, the BBOX1 is a box surrounding the group 1 generated by classifying the point cloud data of the other vehicle AO1, so the BBOX1 in FIG. 4 and the other vehicle AO1 indicated by the broken line in FIG. 7 represent the other vehicle AO1 at the third time, and the BBOX12 in FIG. 4 and the other vehicle AO1 indicated by the solid line in FIG. 7 represent the other vehicle AO1 at the image data acquisition time 4. As shown in FIGS. 4 and 7, when the BBOX1 corresponding to the third time shown in FIG. 4 is associated with the other vehicle AO1 at the image data acquisition time 4 shown in FIG. 7, a deviation occurs between the position of the BBOX1 and the position of the other vehicle AO1 in the image data. In this case, the distance of the other vehicle AO1 from the vehicle 1 may include an error.

On the other hand, in the present embodiment, the BBOX is replaced with the position at the image data acquisition time 4 based on the moving route predicted using the BBOX1 corresponding to the third time. This replacement corrects the deviation between the position of the object in the image data acquired at the image data acquisition time and the position of the BBOX surrounding the group generated from the point cloud data acquired at a time different from the image data acquisition time.

In step S700, the processing unit 40 connects the BBOX 12 with the image data acquisition time 4. The function of step S700 is implemented by the time assign unit 410 of the processing unit 40.

In step S800, the processing unit 40 projects the data of the BBOX replaced with the position at the image data acquisition time 4 in the direction in which the image sensor 30 is directed, thereby converting the BBOX data replaced with the position at the image data acquisition time 4 into two-dimensional data. The processing unit 40 recognizes the other vehicle AO1, which is an object included in the image of the image data, and connects the result of recognition with the BBOX 12. The function of step S800 is realized by the data conversion unit 460 of the processing unit 40.

As described above, in the present embodiment, a group generated by classifying the point cloud data acquired at a time different from the acquisition time of the related data is replaced with the position at the same time as the acquisition time of the related data and then connected with the related data. As a result, compared to a feature in which a plurality of data acquired at different times are associated to each other without being replaced with positions at the same time, the misalignment of positions between the objects represented by the image data as the related data and the objects represented by the group can be improved to be smaller. As a result, the error in the calculated distance to the object can be reduced.

In this embodiment, by surrounding the point cloud belonging to the group with a BBOX and assigning a position label to the vertices of the BBOX, for example, compared to the feature in which position labels are assigned to all the points of the point cloud constituting the group, it is easy to predict the moving route of the BBOX since the position label and the speed label are easily assigned.

In this embodiment, the type of BBOX, the speed of the BBOX to which the moving object on-flag is assigned, the front/rear flag indicating whether there is another BBOX in front of or behind the BBOX to which the moving object on-flag is assigned, and the size of the BBOX are attached, it is possible to generate the BBOX with a wider variety of information compared to a feature in which these labels are not attached.

In this embodiment, by using two methods, an algorithm for grouping point clouds and a tool for assigning labels to groups, it is possible to easily and quickly perform the grouping of the point clouds and assigning of the labels, compared with a case where these methods are not used.

Further, in the present embodiment, the point cloud data acquired at the third time, which is the closest time to the image data acquisition time 4, and the point cloud data acquired at the second time, which is the second closest time to the image data acquisition time 4 are used. By using the point cloud data acquired at the time closest to the time when the image data was acquired and the point cloud data acquired at the second closest time to the time when the image data was acquired, it is possible to predict the moving route more accurately, compared with a case where the moving route is predicted based on only the point cloud data acquired at a time farther than those times.

In the present embodiment, all point cloud data out of a plurality of sets of point cloud data generated at regular time intervals are used. For example, more data can be acquired in the processing up to step S800 compared to a case for using only a part of point cloud data among multiple sets of point cloud data generated at constant time intervals.

The data generated by the processing up to step S800 and stored in the ROM can be used as a training data set for machine learning. A machine learning device mounted on a moving object learns by executing the processing from step S100 to step S800 on objects around the moving object using the training data set. By repeating learning by the machine learning device, it becomes possible to generate groups quickly and with high accuracy. As a result, the positional deviation between the object represented by the related data and the object represented by the group is corrected with high accuracy, and the error in the calculated distance to the object can be reduced.

### B. Second Embodiment

In the first embodiment, processing by the processing unit 40 is performed using all point cloud data out of ten point cloud data generated in one second. In the second embodiment, among the plurality of sets of point cloud data acquired at constant time intervals, the processing unit 40 uses a plurality of sets of point cloud data at time intervals that are integral multiples of the time interval to execute the process. Since other configurations are the same as those of the first embodiment, the same reference numerals are given and detailed description thereof is omitted.

In the second embodiment, in step S100, the processing unit 40 prepares multiple sets of point cloud data at time intervals of 0.3 seconds, which is three times the interval of 0.1 seconds, among a plurality of sets of point cloud data acquired at intervals of 0.1 seconds. The point cloud data prepared in step S100 are the point cloud data acquired at the third time, the sixth time, and the ninth time. Other point cloud data acquired at times from the first time to the tenth time are not used in the second embodiment. In step S200, the processing unit 40 classifies the point cloud data acquired at the third time, the sixth time, and the ninth time, generates groups, and surrounds each group in a BBOX.

In FIG. 8, the BBOX 21 corresponding to the 3rd time, the 6th time, and the 9th time is shown. The BBOX21 corresponds to BBOX1 in the first embodiment. Prediction of the moving route after the ninth time will be described below. In step S400, the processing unit 40 predicts the moving route of the BBOX 21 after the 9th time from the labels attached to the BBOX 21 corresponding to the 3rd time, the 6th time, and the 9th time.

In step S600, the processing unit 40 replaces the BBOX 21 with the position at the image data acquisition time 10 to generate the BBOX 22 based on the predicted moving route. In FIG. 8, the BBOX 22 corresponding to the image data acquisition time 10 is represented by a dashed box. In step S700, the processing unit 40 connects the BBOX 22 with the image data acquisition time 10.

In the second embodiment, when the user manually groups the point cloud and assigns labels in step S200, or when the user manually assigns labels to groups or BBOXes in step S300, it is possible to grouping and assigning labels easily compared with a case where the user manually handles all the point cloud data.

### C. Third Embodiment

In the first embodiment, among the first time to the third time, which are the acquisition times of the point cloud data, the first time, which is the third closest time to the acquisition time 4 of the image data, is prior to the third time which is the closest time of the image data acquisition time 4 and the second time which is the second closest time of the image data acquisition time 4. In the third embodiment, the third closest time is a time later than the closest time and the second closest time. Since other configurations are the same as those of the first embodiment, the same reference numerals are given and detailed description thereof is omitted.

In the third embodiment, the BBOX 32 corresponding to image data acquisition time 5 shown in FIG. 9 will be described. In the third embodiment, the point cloud data acquired at the fourth time, the fifth time, and the sixth time are used. The time difference between the image data acquisition time 5 and the fifth time is 0.04 seconds.

The processing unit 40 causes the storage unit 50 to store the point cloud data acquired up to the tenth time and the image data acquired up to the image data acquisition time 10 in advance. The processing unit 40 predicts the moving route of the BBOX 31 based on the point cloud data acquired at the fifth time that is closest to the image data acquisition time 5, the fourth time that is the second closest time, and the sixth time that is the third closest time. The BBOX31 corresponds to BBOX1 in the first embodiment. Then, the processing unit 40 replaces the BBOX with the position at the image data acquisition time 5 based on the moving route of the BBOX 31 to generate the BBOX 32. The processing unit 40 then associates the new BBOX 32 with the image data acquisition 5.

### D. Fourth Embodiment

The fourth embodiment differs from the above embodiments in that a ranging device 70 is used instead of the image sensor 30 as a device for obtaining information about the surroundings of the vehicle. Since other configurations are the same as those of the first embodiment, the same reference numerals are given and detailed description thereof is omitted.

The ranging device 70 irradiates an object around the vehicle 1 with measurement light, and generates point cloud data, which is three-dimensional data, from reflected light reflected from the object. In the fourth embodiment, a millimeter wave radar is used as the ranging device 70. In the fourth embodiment, each of the four ranging devices 70 is mounted close to one of the point cloud data generation unit 20. The ranging device 70 is mounted so that the range for acquiring the point cloud data overlaps with the measurement range of the adjacent point cloud data generation unit 20. The range irradiated with the measurement light is a range extending in the vertical and horizontal directions. In this embodiment, the ranging device 70 acquires 10 point cloud data at time intervals of 0.1 seconds. The ranging device 70 transmits the acquired point cloud data to the processing unit 40.

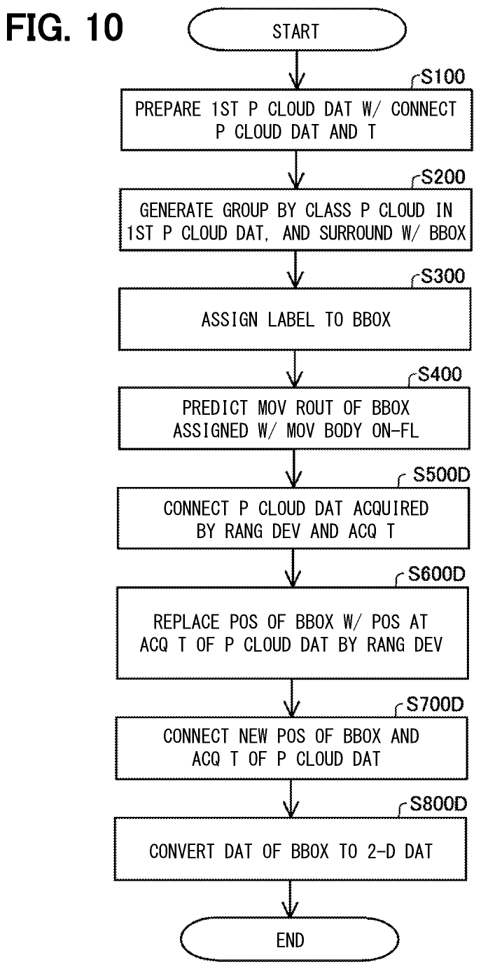

Processing of the fourth embodiment will be described with reference to FIG. 10. In step S500D of FIG. 10, the processing unit 40 associates the point cloud data with the time when the ranging device 70 acquired the point cloud data. In step S600D, the processing unit 40 replaces the BBOX with the moving body on-flag attached with the time when the ranging device 70 acquires the point cloud data based on the moving route. In step S700D, the processing unit 40 associates the generated new BBOX with the time when the ranging device 70 acquired the point cloud data.

In the fourth embodiment, three-dimensional data of different asynchronous devices can be associated with each other. Thereby, the distance to the object can be measured with high accuracy. Further, when comparing the millimeter wave radar used as the ranging device 70 and the LIDAR sensor used as the point cloud data generation unit 20, the resolution of the millimeter wave radar is low. By using the point cloud data generation unit 20 having a resolution higher than that of the millimeter wave radar, it is possible to generate a BBOX with higher accuracy than when the BBOX is generated using the millimeter wave radar.

### E. Fifth Embodiment

The fifth embodiment differs from the above embodiments in that a ranging device 70 is used in addition to the image sensor 30. Since other configurations are the same as those of the first embodiment, the same reference numerals are given and detailed description thereof is omitted. In the fifth embodiment, a millimeter wave radar is used as the ranging device 70 as in the fourth embodiment.

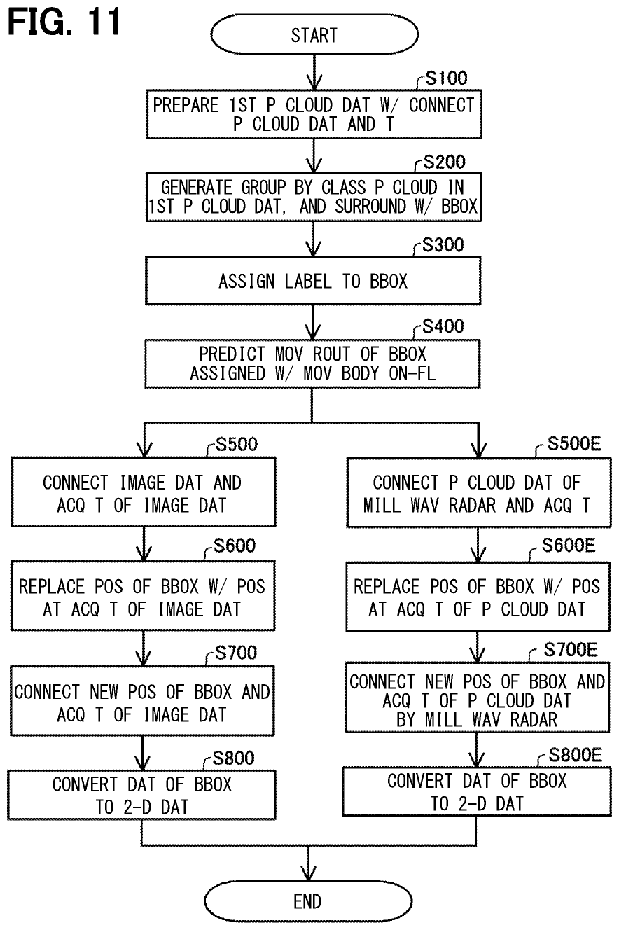

In step S500E of FIG. 11, the processing unit 40 associates the time when the ranging device 70 acquired the point cloud data with the point cloud data acquired by the ranging device 70. The time when the ranging device 70 acquires the point cloud data is a time different from the image data acquisition time and the time when the point cloud data generation unit 20 acquires the point cloud data.

In step S600E, the processing unit 40 generates a new BBOX by replacing the BBOX with the position at the time when the ranging device 70 acquired the point cloud data. The BBOX generated in step S600E is different from the BBOX replaced with the position at the image data acquisition time in step S600. In step S700E, the processing unit 40 associates the new BBOX with the time when the ranging device 70 acquired the point cloud data. In step S800E, the processing unit 40 converts the BBOX data associated in step S700E into two-dimensional data.

In the fifth embodiment, by using the image sensor 30 and the ranging device 70 together, two types of data, that are two-dimensional image data and three-dimensional point cloud data, can be associated with a group or BBOX.

### F. Other Embodiments

### F1. Other Embodiment 1

(1) In the above embodiment, LIDAR sensors are used as point cloud data generation units, and are mounted on the front, rear, left and right sides of the vehicle. A device that generates a point cloud using a RADAR sensor may be used as the point cloud data generation unit. In addition, the point cloud data generation units may be mounted on the top and bottom of the vehicle body instead of on the front, rear, left and right sides of the vehicle, for example, and may be mounted only on the front side and the rear side of the vehicle. Thus, the point cloud data generation units with the number of the units different from the above embodiments may be mounted at different positions.
(2) In the above embodiment, the connection device 10 is mounted on the vehicle 1. The connection device 10 may be mounted on a moving object other than a vehicle, such as a ship or an airplane.
(3) In the above embodiments, the scan unit irradiates the laser light ten times per second at time intervals of 0.1 seconds. The scan unit may irradiate laser light at time intervals different from 0.1 seconds, such as 0.2 seconds or 0.5 seconds. Moreover, each time interval of the laser light may be different, for example, the time interval of the laser light may be 0.3 seconds after 0.1 seconds.
(4) In the above embodiments, the control unit 230 generates 10 point cloud data per second with a time interval of 0.1 second. The control unit may generate point cloud data at intervals different from 0.1 seconds, such as 0.2 seconds or 0.5 seconds.
(5) In the first embodiment, image data is generated using a camera, which is the image sensor 30. A monocular camera, a stereo camera, a thermography camera, an infrared camera, a thermal image camera, or the like can be used as the camera. Related data, which is information about the surroundings, may be obtained using a surrounding information acquisition unit other than the image sensor. For example, as shown in the fourth embodiment, the ranging device 70 may be used to generate point cloud data, which is three-dimensional data. Other than the millimeter wave radar shown in the fourth embodiment, sonar and devices using infrared rays or laser light may be used. Also, the surrounding information acquisition units with the number of units different from the above embodiments may be mounted at positions different from those in the above embodiment.
(6) In the embodiments, the image sensor 30 acquires 10 image data per second with a time interval of 0.1 second. The image sensor 30 may acquire image data at intervals other than 0.1 seconds, such as five image data acquisitions per second at intervals of 0.2 seconds.
(7) In the above embodiments, the case where “there are other groups in front of or behind” means that when viewed along the direction in which the measurement light of the point cloud data generation unit 20 is irradiated, the BBOX and the other BBOX are overlapping. The case where “there are other groups in front of or behind” may mean that at least one of the point clouds constituting each group when viewed along the direction in which the measurement light of the point cloud data generation unit 20 is irradiated overlap each other.
(8) In the above embodiment, in step S200, group 1 is assigned as the group forming the other vehicle AO1, group 2 is assigned as the group forming the pedestrian AO2, group 3 is assigned as the group forming the plant RO3, and the group 4 is assigned as the group forming the oncoming vehicle AO4. The subsequent processing may be executed without naming the groups.
(9) In the above embodiment, three sets of point cloud data, i.e., the first point cloud data DA1 through the first point cloud data DA3 acquired at the first time through the third time are used. Two or more sets of point cloud data different from three sets, such as two sets, five sets, or eight sets of point cloud data acquired at different times, may be used instead of the three sets of point cloud data.
(10) In the above embodiment, in step S400, the processing unit 40 gives the BBOX12 the same label as the label given to the BBOX1 in step S400, in addition to the position label. In step S400, the processing unit may not assign labels other than the position label.
(11) In the first embodiment, point cloud data acquired at the first to third times are simultaneously processed. The processes do not have to be performed at the same time. For example, the process up to the labeling of the point cloud data acquired at the first time and the second time may be performed before the processing of the point cloud data acquired at the third time.

### F2. Other Embodiments 2

(1) In the above embodiment, groups generated by classifying point cloud data are enclosed in a BBOX, which is a three-dimensional rectangular box, the moving route of the BBOX is predicted, the BBOX is replaced with the position at the acquisition time of the image data acquired by the image sensor 30 is replaced, and the replaced BBOX is connected to the acquisition time of the image data. The process of enclosing the group with the BBOX may not be performed. The point cloud of the group generated by classifying the point cloud data may be replaced with the position at the acquisition time of the related data, the new point cloud data may be generated, and the new point cloud data may be connected to the acquisition time of the related data.

In a mode in which the group is not surrounded by the BBOX, a label may be assigned to an arbitrary point in the point cloud for forming the group. Also, a label may be attached to a line connecting points located on the outermost side of the group in the point cloud for forming the groups.

In a mode in which the group is not surrounded by the BBOX, the moving route of the group that is commonly included in each of the two or more point cloud data and to which the moving body on-flag is attached may be predicted. It is not necessary for all of the point clouds that forms the group to be included in common, as long as the point clouds are included in common to the extent that the point cloud can be recognized as the same group by the algorithm for grouping the point clouds or the user. In the case of a manual grouping method, the extent to which the point cloud can be recognized as the same group may differ depending on the operator. In the case of automatic methods using algorithms, it is predetermined how many point clouds must be included in common.

In a mode in which the group is not surrounded by the BBOX, based on the predicted moving route, the position of the point cloud of the group to which the moving object on-flag is attached may be replaced with the position at the acquisition time of the related data, which is the data obtained by the device for acquiring the surrounding information, to connect the new position of the group with the acquisition time of the related data.
(2) In the above embodiment, the processing unit 40 deletes the point cloud of the groups included in the BBOX after generating the BBOX. After generating the BBOX, the processing unit may execute subsequent processing without deleting the point cloud of the groups included in the BBOX.
(3) In the above embodiment, the position labels attached to the BBOX1 are assigned to all the vertices of the BBOX1. The position labels attached to the BBOX1 may be assigned to any number of vertices, such as one vertex or five vertices, of the box of the BBOX, or may be assigned to the center of gravity of the BBOX.
(4) In the above embodiment, the speed of one vertex is predicted from the movement distance of the label at the position of the one vertex, and the same processing is performed on the other vertices of the BBOX1 to calculate the average, so that the speed label of the BBOX1 is determined. For example, the fastest speed among the calculated speeds may be set as the speed of the BBOX.
(5) In the above embodiment, the moving route of the BBOX1 up to the second time is predicted based on the BBOX1 corresponding to the first time. Based on the BBOX1 corresponding to the second time, the moving route of the BBOX1 up to the third time is predicted. Based on the BBOX1 corresponding to the third time, the moving route of the BBOX1 after the third time is predicted. The BBOX1 corresponding to each time may be used to predict the moving route after the next time. In this case, the moving route may be updated by the BBOX1 generated at the next time. For example, after the moving route after the second time is predicted by the BBOX1 corresponding to the first time, the position of the BBOX1 at the second time may be corrected by the position label of the BBOX1 corresponding to the second time. After the second time, the predicted moving route may be updated by the label assigned to the BBOX1 corresponding to the second time.
(6) In the above embodiment, the processing unit 40 names the BBOX surrounding the group 1 as the BBOX1, the BBOX surrounding the group 2 as the BBOX2, the BBOX surrounding the group 3 as the BBOX3, and the BBOX surrounding the group 4 as the BBOX4. Naming may be done manually by the user or automatically using an algorithm. Alternatively, it may not be necessary to name the BBOX.
(7) In the above embodiment, the average speed of the BBOX1 is calculated from the position labels of all the vertices of the BBOX1. The average speed of the BBOX1 may be calculated from the position labels of any number of vertex of the BBOX1, and the speed calculated from the label of any one vertex of the BBOX1 may be set as the speed of the BBOX.

### F3. Other Embodiments 3

(1) In this embodiment, the label assign unit 43 assigns a BBOX type label, a moving body flag label indicating whether or not the BBOX is a moving body, a BBOX position label attached with a moving body on-flag which is a moving body flag indicating that the BBOX is a moving body, a BBOX speed label attached with a moving body on-flag, a front-rear flag label indicating whether or not there is another BBOX in front of or behind the BBOX assigned with the moving body on-flag, and a BBOX dimension label. Even if the type of group, the speed of the group with the moving body on-flag, and the front and rear flag indicating whether or not there is another group in front of or behind the group with the moving body on-flag may not be assigned. Any one or more of these labels may be assigned. Also, the BBOX dimension label may not be assigned.

### F4. Other Embodiments 4

(1) Two or more of a millimeter-wave radar, a sonar, and a device using infrared rays or laser light may be used as devices for acquiring surrounding information. The group to which the moving body on-flag is assigned may be replaced with the position at the acquisition time of the three-dimensional data acquired at different times by two or more devices to connect the group with the acquisition time of the three-dimensional data. Alternatively, in addition to two or more of a millimeter-wave radar, a sonar, and a device using infrared rays or laser light, an image sensor may be used as a device for acquiring surrounding information. A device that acquires surrounding information is also defined as a surrounding information acquisition unit.

### F5. Other Embodiments 5

(1) In the above embodiment, the point clouds are classified using an algorithm for grouping the point clouds, and the labels are automatically assigned using a tool for assigning labels to groups. One of the following methods: using an algorithm to group the point cloud, or automatically or partially automatically using a group labeling tool to label the groups may be used. Partially automatically method means, for example, that the group is manually labeled as a “vehicle” and the group labeling tool labels the position of the group labeled the vehicle.

### F6. Other Embodiments 6

(1) In the present embodiment, subsequent processing is performed using all point cloud data among a plurality of sets of point cloud data acquired at intervals of 0.1 seconds, which are constant time intervals. All point cloud data out of multiple sets of point cloud data acquired at different time intervals may be used.

### F7. Other Embodiments 7

(1) In the above-described second embodiment, out of a plurality of sets of point cloud data acquired at intervals of 0.1 seconds, the point cloud data at intervals three times the interval of 0.1 seconds are used. For example, the point cloud data at an interval other than 3 times the interval of 0.1 second, such as twice or five times, may be used.
(2) In the second embodiment described above, among a plurality of sets of point cloud data acquired at intervals of 0.1 seconds, all point cloud data are connected to the acquisition times. The point cloud data at intervals three times the interval of one second is used. For example, the point cloud data is generated by the point cloud data generation unit at intervals of 0.1 seconds, and only the point cloud data at intervals three times the interval of 0.1 seconds are connected to the acquisition time, and processing after step S100 may be performed.

### E8. Other Embodiments 8

(1) In the above embodiment, the processing unit 40 predicts the moving route of the BBOX by approximating the motion of the BBOX1 to uniform linear motion. The processing unit may non-linearly predict the moving route of the group or the BBOX to which the moving body on-flag is assigned using a Kalman filter or a particle filter.

### F9. Other Embodiments 9

(1) In the above embodiment, the point cloud data acquired at the time closest to the acquisition time of the image data and the point cloud data acquired at the second closest time are used. For example, only the point cloud data acquired at the closest time and the point cloud data acquired at the third closest time may be used, or only the point cloud data acquired at the second closest time and the point cloud data acquired at the fourth closest time may be used. Thus, the point cloud data acquired at the closest time and the point cloud data other than the point cloud data acquired at the second closest time may be used.

### F10. Other Embodiments 10

(1) In the above embodiment, the point cloud data acquired at the third closest time to the acquisition time of the related data is used. The point cloud data acquired at a time farther than the third closest time, such as the fourth closest time, the fifth closest time, or the sixth closest time, may be used. Alternatively, all acquired point cloud data may be used.
(2) In the third embodiment, the deviation between the image data acquisition time 5 and the fifth time is 0.04 seconds. For example, the difference between image data acquisition time 5 and the fourth and fifth times is 0.05 seconds, and the difference between image data acquisition time 5 and the third and sixth times is 0.15 seconds. In this aspect, the fifth time may be defined as the closest time to the image data acquisition time 5, the fourth time may be defined as the second closest time, and the sixth time may be defined as the third closest time. Alternatively, the time closest to the image data acquisition time 5 may be defined as the fourth time, the second closest time may be defined as the fifth time, and the third closest time may be defined as the third time.

The third closest time may be a time before the closest time and the second closest time, or the third closest time may be a time after the closest time and the second closest time. Thus, various combinations of point cloud data acquired at different times can be used.

### F11. Other Embodiments 11

(1) In the first embodiment, the deviation between the third time and the image data acquisition time 4 is 0.04 seconds. The difference between the image data acquisition time and the point cloud data acquisition time may be a number of seconds different from 0.04 seconds, such as 0.05 seconds, 0.1 seconds, or 0.5 seconds. It may be desirable that the difference between the acquisition time closest to the acquisition time of the related data and the acquisition time of the related data among the acquisition times of the plurality of sets of point cloud data is between 0.1 millisecond and 1 second.

### F12. Other Embodiments 12

(1) In the above embodiment, the connection device 10 includes the display unit 60 and the data conversion unit 460. Alternatively, the connection device may not include the display unit and the data conversion unit.

The present disclosure should not be limited to the embodiments or modifications described above, and various other embodiments may be implemented without departing from the scope of the present disclosure. For example, the technical features in each embodiment corresponding to the technical features in the form described in the summary may be used to solve some or all of the above-described problems, or to provide one of the above-described effects. In order to achieve a part or all, replacement or combination can be appropriately performed. Also, some of the technical features may be omitted as appropriate.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A method of connecting a point cloud data with a related data, comprising:
preparing a plurality of sets of point cloud data, each of the plurality of sets of point cloud data including information of a point cloud connected to three-dimensional position information, and each of the plurality of point cloud data connected to acquisition time;
generating at least one group by classifying the point cloud in each of two or more of sets of point cloud data, and assigning the at least one group to a plurality of labels including a position label and a moving body label indicating whether the at least one group provides a moving body;
predicting a moving route of the at least one group assigned a moving body on-flag in the moving body label based on the position label of the at least one group, which is included in each of the two or more of sets of point cloud data and assigned the moving body on-flag indicating that the at least one group provides the moving body; and
replacing the at least one group, to which the moving body on-flag is assigned, with a position at acquisition time of the related data that is acquired by a device for acquiring surrounding information, according to the moving route, and connecting the acquisition time of the related data to the at least one group.

2. The method according to claim 1, wherein:
the generating of the at least one group includes:
surrounding the point cloud included in each of the at least one group by a three-dimensional rectangular box for each of the at least one group; and
assigning the position label to at least one vertex of the three-dimensional rectangular box.

3. The method according to claim 1, wherein:
the generating of the at least one group includes: further assigning the at least one group to at least one of: a type label indicating a type of the at least one group; a speed label indicating a speed of the at least one group to which the moving body on-flag is assigned; and a front and rear flag label indicating whether an other group is disposed in front of or behind the at least one group to which the moving body on-flag is assigned.

4. The method according to claim 1, wherein:
the device for acquiring the surrounding information is an image sensor that acquires two-dimensional image data by imaging a surrounding object, the method further comprising:
replacing the at least one group to which the moving body on-flag is assigned with a position at acquisition time of three-dimensional data acquired by at least one of a millimeter wave radar, a sonar and a device using infrared light or laser light, according to the moving route, and connecting the acquisition time of the three-dimensional data to the at least one group.

5. The method according to claim 1, wherein:
the generating of the at least one group is executed by at least one of:
a method using an algorithm for grouping the point cloud; and
a method for automatically or partially automatically assigning the plurality of labels to the at least one group using a tool for labeling the at least one group.

6. The method according to claim 1, wherein:
the plurality of sets of point cloud data in the preparing of the plurality of sets of point cloud data includes:
all of the plurality of sets of point cloud data among the plurality of sets of point cloud data acquired at regular time intervals from each other.

7. The method according to claim 1, wherein:
the plurality of sets of point cloud data in the preparing of the plurality of sets of point cloud data includes: a part of the plurality of sets of point cloud data among the plurality of sets of point cloud data acquired at regular time intervals from each other; and
the part of the plurality of sets of point cloud data is acquired at time intervals that are integral multiples of the regular time intervals.

8. The method according to claim 1, wherein:
the predicting of the moving route of the at least one group is executed by one of:
a method of approximating a movement of the at least one group to which the moving body on-flag is assigned to uniform linear motion, and predicting the moving route of the at least one group to which the moving body on-flag is assigned; and
a method of non-linearly predicting the moving route of the at least one group to which the moving body on-flag is assigned using a Kalman filter or a particle filter.

9. The method according to claim 1, wherein:
the two or more of sets of point cloud data include point cloud data acquired at a closest time to the acquisition time of the related data and point cloud data acquired at a second closest time to the acquisition time of the related data.

10. The method according to claim 9, wherein:
the two or more of sets of point cloud data further include point cloud data acquired at a third closest time to the acquisition time of the related data; and
the third closest time is prior to the closest time and the second closest time, or the third closest time is after the closest time and the second closest time.

11. The method according to claim 1, wherein:
a time difference between the acquisition time of the related data and acquisition time of the plurality of sets of point cloud data closest to the acquisition time of the related data is disposed between 0.1 millisecond and 1 second.

12. The method according to claim 1, further comprising:
converting data in the at least one group replaced with the position at the acquisition time of the related data into a two-dimensional data by projecting the data in the at least one group replaced with the position at the acquisition time of the related data in a direction to which the device for acquiring the surrounding information is directed;
recognizing an object included in the related data; and
connecting a recognition result with the at least one group.

13. A non-transitory tangible computer readable storage medium comprising instructions being executed by a computer, the instructions including a computer-implemented method according to claim 1.

14. A training data set generated by the method according to claim 1.

15. A device for connecting a point cloud data with a related data, comprising:
a point cloud data generation unit that emits measurement light and generates a plurality of sets of point cloud data including information of a point cloud connected to three-dimensional position information based on reflected light from an object;
a surrounding information acquisition unit that acquires the related data that provides surrounding information; and
a processing unit that generates at least one group by classifying the point cloud in each of the plurality of sets of point cloud data, predicts a moving route of the at least one group, replaces the at least one group with a position at acquisition time of the related data, and connecting the acquisition time of the related data to the at least one group, wherein:
the processing unit includes:
a time assign unit that connecting the point cloud data in each of the plurality of sets of point cloud data to acquisition time of the point cloud data in each of the plurality of sets of point cloud data, and connecting the related data to acquisition time of the related data;
a group generation unit that generates the at least one group by classifying the point cloud in each of two or more of sets of point cloud data;
a label assign unit that assigns each of the at least one group to a plurality of labels including a position label and a moving body label indicating whether the at least one group provides a moving body;
a route prediction unit that predicts a moving route of the at least one group assigned a moving body on-flag in the moving body label based on the position label of the at least one group, which is included in each of the two or more of sets of point cloud data and assigned the moving body on-flag indicating that the at least one group provides the moving body; and
a position re-acquisition unit that replaces the at least one group to which the moving object on-flag is assigned with a position at the acquisition time of the related data based on the moving route.

16. The device according to claim 15, further comprising:
one or more processors, wherein:
the one or more processors provide at least one of: the point cloud data generation unit; the surrounding information acquisition unit; and the processing unit.
